(19) United States
(12) Patent Application Publication
(10) Pub. No.: US 2002/0117896 A1
(43) Pub. Date: Aug. 29, 2002

(54) Feeder apparatus

(75) Inventor: Takashi Gohara, Shizuoka (JP)

Correspondence Address: SUGHRUE MION, PLLC, 2100 Pennsylvania Avenue, NW, Washington, DC, 20037-3213, US

(73) Assignee: YAZAKI CORPORATION

(21) Appl. No.: 10/073,057

(22) Filed: Feb. 12, 2002

(30) Foreign Application Priority Data
Feb. 21, 2001 (JP) P2001-45387

(51) Int. Cl. B60L 1/00

(52) U.S. Cl. 307/10.1; 307/104

(57) ABSTRACT

An arrangement is provided such that electric power is supplied through the action of mutual induction between two members on a vehicle body (2) side a sliding door (3) side. In addition, an arrangement is provided such that respectively different induced electromotive forces are caused to occur in secondary-side feeding coils (10) and (119, and the supply of electric power is effected for each of the secondary-side feeding coils (10, 11). An arrangement is provided such that a first storage member (20) and a second storage member (22) are respectively connected to the secondary-side feeding coils (10, 11) with a rectifier circuit (12) interposed therebetween, so as to supply electric power corresponding to characteristic requirements of corresponding loads.

### BACKGROUND OF THE INVENTION

The present invention relates to a feeder apparatus for supplying electric power from one of two members located in proximity to each other to the other member through the action of mutual induction.

As a feeder apparatus of this type, a feeder apparatus for supplying electric power from a vehicle body to a door unit such as a sliding door (a sliding-door feeder apparatus for an automobile) is widely known.

FIG. 5 is a block diagram illustrating the configuration of a conventional feeder apparatus.

In FIG. 5, a feeder section 110 for supplying electric power by the action of mutual induction and an infrared-ray transmitting section 120 serving as a signal transmitting means are provided at a door joining portion for connecting a vehicle body (hereafter abbreviated as the body side, the same applying to the drawing as well) corresponding to one of two members and a door unit (hereafter abbreviated as the door side, the same applying to the drawing as well) corresponding to the other one of the two members and provided in such a manner as to be openable with respect to the body side.

A primary coil 111 of the feeder section 110 and a transmitter unit 121 of the infrared-ray transmitting section 120 are disposed on the body side. Meanwhile, a secondary coil 112 of the feeder section 110 and a receiver unit 122 of the infrared-ray transmitting section 120 are disposed on the door side.

On the body side, a primary-coil oscillation driver 113 for supplying an ac electromotive force to the primary coil 111 upon receiving electric power from a battery is connected to the primary coil 111 of the feeder section 110, while a light-emitting drive unit 123 for outputting a drive signal for the transmitter unit 121 upon receiving a control signal, an audio signal, or the like from a circuit on the body side is connected to the transmitter unit 121 of the infrared-ray transmitting section 120. The light-emitting drive unit 123 is comprised of an A/D converter, a controller, an infrared light-emitting element, and the like.

On the door side, a rectifier 114 for effecting ac-dc conversion and rectification with respect to the power supply based on the action of mutual induction is connected to the secondary coil 112 of the feeder section 110. Disposed on the output side of the rectifier 114 is a secondary power source 117 in which a secondary battery 115 and a capacitor 116 are connected in parallel. Disposed on that output side is a door-side control unit 118 for controlling the driving of intermittent loads (loads) for power windows, door locks, and the like.

A drive motor 128 for a power window, a drive motor 129 for door locks, drive motors 130 and 131 for adjusting remote control-type door mirrors are respectively connected to the door-side control unit 118. The door-side control unit 118 is comprised of a processor 126 for effecting various processing and a switch unit 127 for turning on and off the drive signals of the drive motors 128 to 131.

The receiver unit 122 of the infrared-ray transmitting section 120 on the door side is comprised of an infrared light receiving element, a preamplifier, and the like. In addition, an electric control unit (ECU) 124 for controlling communication for such as a control signal and an audio signal is connected to the output end of the receiver unit 122.

The ECU 124 is comprised of a processor for effecting various processing and an audio circuit. A control output line from the ECU 124 is connected to the door-side control unit 118, and a speaker 125 for reproducing an audio signal is connected to an audio output line. Power input terminals of the door-side control unit 118 and the ECU 124 are connected to a power supply line to which the secondary power source 117 is connected.

With the above-described conventional technique, electric power of 12 V, for instance, is supplied to the power supply line to which the secondary power source 117 is connected, and the drive circuit of the door-side control unit 118 is arranged to be connected thereto. In addition, the 12-volt power supply is arranged to be converted to a voltage of 5 V or 3 V and supplied as a power supply for the control circuit of the door-side control unit 118 and a power supply for the control circuit of the ECU 124.

Accordingly, the conventional feeder apparatus requires voltage conversion circuit components, and the voltage conversion circuit components have been a factor for an increase in the number of components (resulting in increased cost). In addition, since the power supply is converted to a voltage of 5 V or 3 V for control, in a case where voltage conversion is effected by series regulation or switching regulation, there have been problems in that a power loss can occur due to the heat generation by the portion of a series drop and that noise can occur due to switching.

It should be noted that if the secondary power source 117 is configured by a single voltage storage device, the capacity of the storage member becomes large (since it is necessary to satisfy all the load characteristic requirements for the aforementioned intermittent load, the door-side control unit 118, and the ECU 124). Therefore, there have been problems including the increase in weight, the need to secure the space, increased cost, and an increase in the amount of power generated by the body-side battery.

### SUMMARY OF THE INVENTION

The invention has been devised in view of the above-described circumstances, and its object is to provide a feeder apparatus which is capable of supplying electric power efficiently with reduced cost.

In order to solve the aforesaid object, the invention is characterized by having the following arrangement.

(1) A feeder apparatus:

a first member;

a second member adapted to be brought into close proximity to the first member to supply electric power from the first member to the second member;

at least one primary coil for feeding electric power provided on the first member; and

a plurality of secondary coils for feeding electric power which have different winding ratios to generate different induced electromotive forces when the first member brought into close proximity to the second member, and are provided on the second member.

(2) The feeder apparatus according to (1), wherein storage members corresponding to characteristic requirements of corresponding loads are respectively connected to the plurality of secondary coils through a rectifier circuit.

(3) The feeder apparatus according to (2), wherein the first member is provided on a vehicle body, and the second member is provided on a slide door slidably mounted on the vehicle body.

(4) The feeder apparatus according to (3), wherein the primary coil is electrically connected to a battery mounted on the vehicle body, and the storage members are mounted on the slide door.

(5) The feeder apparatus according to (2), wherein the storage members includes a first storage member for supplying electric power to a load driving circuit and a second storage member for supplying electric power to a control circuit.

(6) The feeder apparatus according to (5), wherein the control circuit controls the load driving circuit and monitors a state of charging the first storage member and the second storage member to control it.

### BRIEF DESCRIPTION OF THE DRAWINGS

FIGS. 1A and 1B illustrate an embodiment of a feeder apparatus of the invention which is applied to a sliding door for an automobile, in which Fig. 1A is a schematic block diagram in a state in which a sliding door is closed, and Fig. 1B is a schematic block diagram in a state in which the sliding door is open;

FIG. 2 is a block diagram illustrating a detailed configuration for FIGS. 1A and 1B;

FIG. 3 is a perspective view illustrating an example of arrangement of a primary-side coil unit and a secondary-side coil unit;

FIG. 4 is a circuit diagram illustrating an example of a detailed configuration of a feeder section shown in FIG. 2; and

FIG. 5 is a block diagram illustrating the configuration of a conventional feeder apparatus.

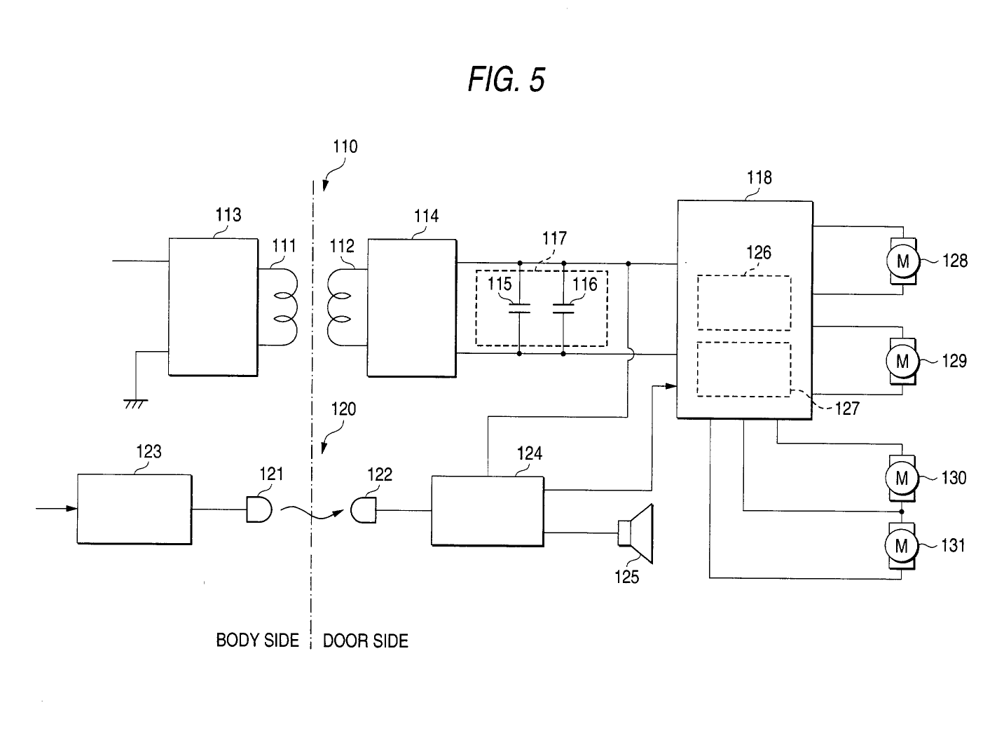

### DETAILED DESCRIPTION OF PREFERRED EMBODIMENTS

Referring now to the drawings, a description will be given of an embodiment of the invention.

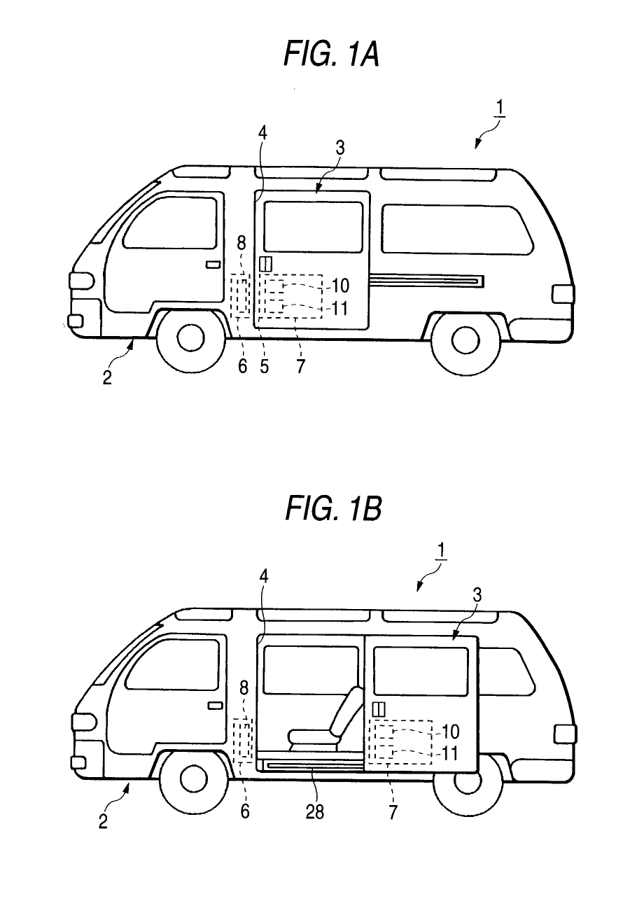

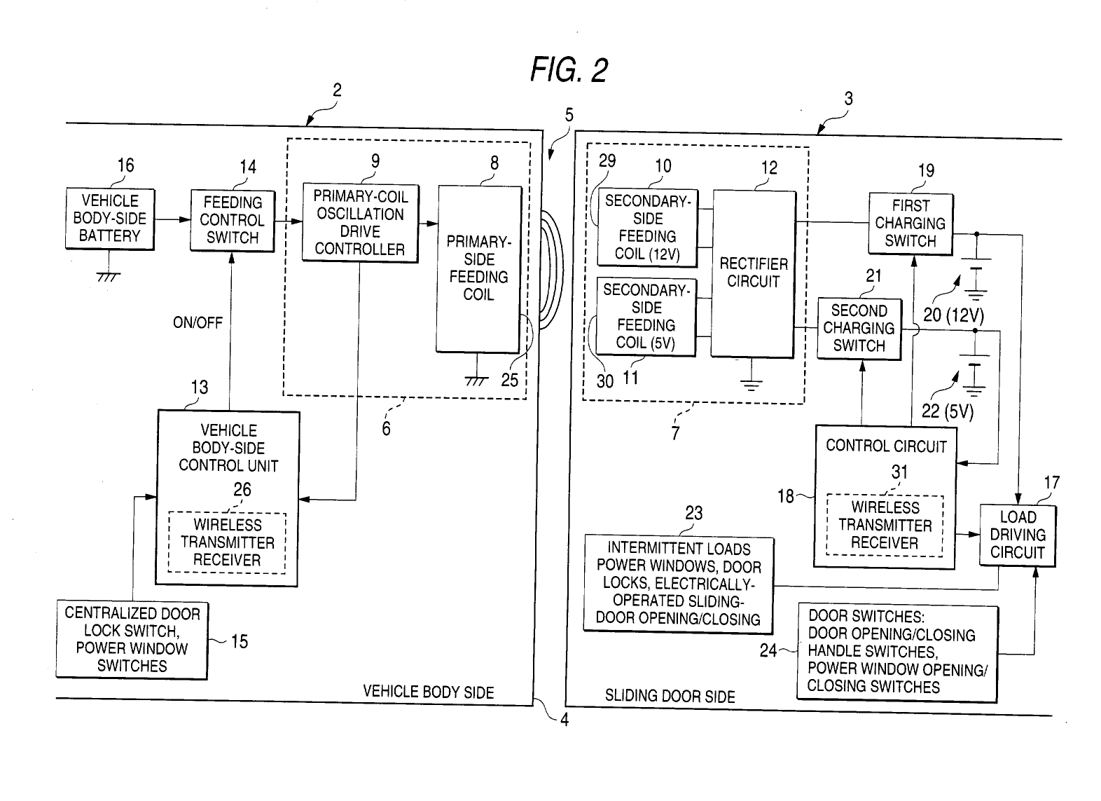

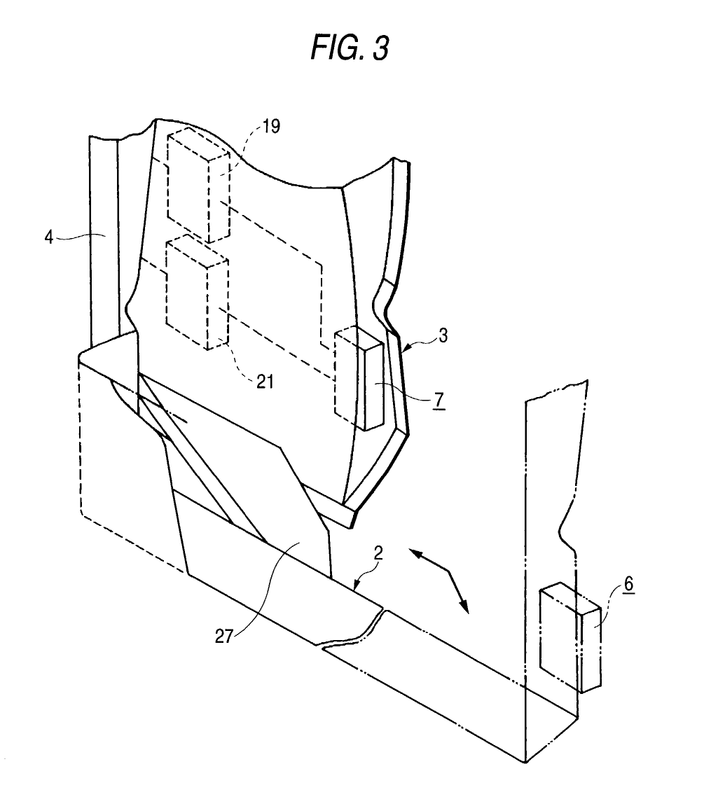

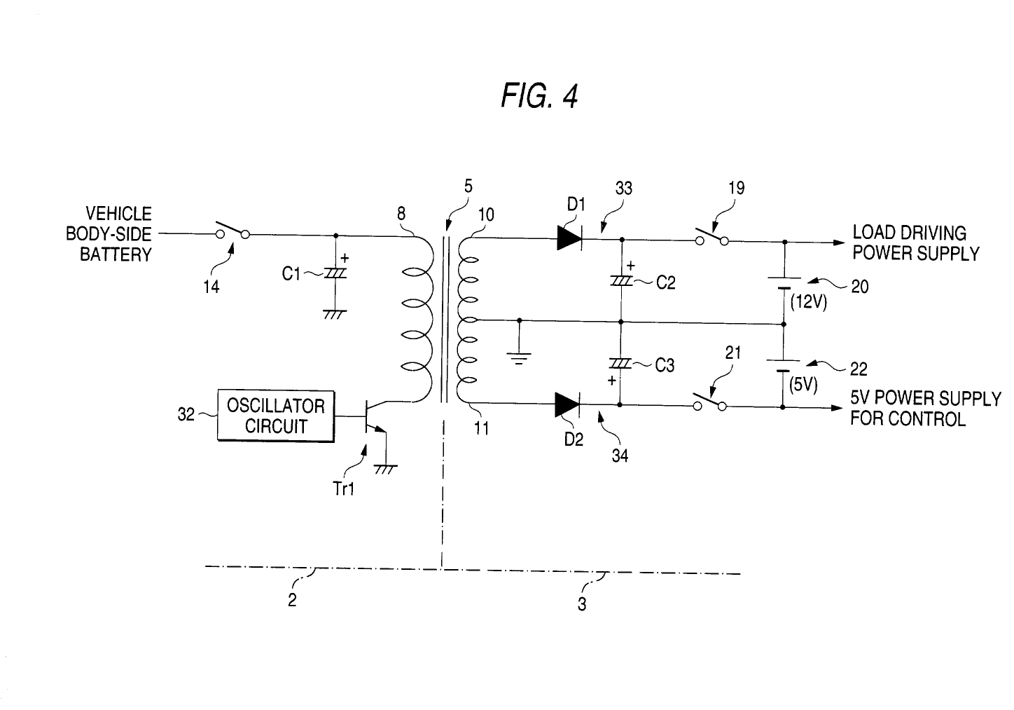

FIGS. 1A and 1B illustrate an embodiment of a feeder apparatus of the invention which is applied to a sliding door for an automobile, in which FIG. 1A is a schematic block diagram in a state in which a sliding door is closed, and FIG. 1B is a schematic block diagram in a state in which the sliding door is open. In addition, FIG. 2 is a block diagram illustrating a detailed configuration for FIGS. 1A and 1B. FIG. 3 is a perspective view illustrating an example of arrangement of a primary-side coil unit and a secondary-side coil unit. FIG. 4 is a circuit diagram illustrating an example of a detailed configuration of a feeder section shown in FIG. 2.

In FIG. 1, a sliding door 3 is attached to a vehicle body 2 of an automobile 1 in such a manner as to be slidable in the longitudinal direction of the vehicle body 2. Reference numeral 4 denotes an open frame portion for the sliding door 3, which is provided in the vehicle body 2. A feeder section 5 for supplying electric power through the action of mutual induction is provided at a door joining portion of the open frame portion 4. The feeder section 5 is provided in such a manner as to straddle the vehicle body 2 and the sliding door 3, and has a primary-side electromagnetic induction coil unit 6 and a secondary-side electromagnetic induction coil unit 7 which are capable of supplying electric power with the sliding door 3 closed.

The primary-side electromagnetic induction coil unit 6 is provided in the open frame portion 4 on the vehicle body 2 side, and is comprised of a primary-side feeding coil 8 and a primary-coil oscillation drive controller 9 (see FIG. 2). Meanwhile, the secondary-side electromagnetic induction coil unit 7 is provided on the sliding door 3 in such a manner as to oppose the primary-side electromagnetic induction coil unit 6, and is comprised of two secondary-side feeding coils 10 and 11 for power supply located in proximity to the aforementioned primary-side feeding coil 8 as well as a rectifier circuit 12 (see FIG. 2).

It should be noted that in this embodiment it is assumed that the vehicle body 2 corresponds to a first member recited in the claims. In addition, it is assumed that the sliding door 3 corresponds to a second member recited in the claims. It is assumed that the primary-side feeding coil 8 corresponds to the primary coil recited in the claims, and that the secondary-side feeding coils 10 and 11 correspond to secondary coils recited in the claims.

In FIG. 2, in addition to the aforementioned primary-side electromagnetic induction coil unit 6, a vehicle body-side control unit 13 is provided on the vehicle body 2. Connected to that vehicle body-side control unit 13 are the primary-side electromagnetic induction coil unit 6, a feeding control switch (feeding control SW) 14, switches 15, and an unillustrated sliding-door open/closed state confirming means (e.g., a known curtain switch). In addition, the primary-side electromagnetic induction coil unit 6 and a vehicle body-side 12-volt battery 16 are connected to the feeding control switch 14. An unillustrated known ignition switch is provided between the feeding control switch 14 and the vehicle body-side battery 16.

Meanwhile, in addition to the aforementioned secondary-side electromagnetic induction coil unit 7, a load driving circuit 17 and a control circuit 18 are provided on the sliding door 3. The load driving circuit 17 and the control circuit 18 are respectively connected to the secondary-side electromagnetic induction coil unit 7, and connected to respective power lines between them are a first charging switch (first charging SW) 19 and a first storage member 20 of 12 V, as well as a second charging switch (second charging SW) 21 and a second storage member 22 of 5 V. An intermittent load 23, door switches 24, and the control circuit 18 are connected to the load driving circuit 17. The first charging switch 19 and the second charging switch 21 are connected to the control circuit 18. It should be noted that it is assumed that the first storage member 20 and the second storage member 22 correspond to the storage members recited in the claims.

The primary-side feeding coil 8 is one having a known configuration, and a covering made of a synthetic resin is provided on its surface so as to demonstrate an effect with respect to splashing with water (such as splashing with drops of water from the outside). In addition, a proximate fitting surface 25 of the primary-side feeding coil 8 is adapted to be exposed from the open frame portion 4 (i.e., exposed to a forward side wall of the vehicle body 2 in the open frame portion 4), and is formed such that the secondary-side feeding coils 10 and 11 are capable of opposing and approaching the same.

The primary-coil oscillation drive controller 9 is arranged to control the oscillation and driving of the primary-side feeding coil 8. In other words, the primary-coil oscillation drive controller 9 has the function of an inverter and the function of switching it, and is arranged to be able to control the excitation of the primary-side feeding coil 8. In addition, the primary-coil oscillation drive controller 9 is configured by including an unillustrated microprocessor.

The vehicle body-side control unit 13 controls various equipment provided in the vehicle body 2, for instance, and is configured by an unillustrated microprocessor and its peripheral circuits. The vehicle body-side control unit 13 is configured by integrally including a wireless transmitter receiver 26 (which may be a separate unit).

The aforementioned microprocessor is configured by including a ROM, a CPU, an EEPROM, a RAM, input/output ports, and the like which are not shown. The ROM is a read-only memory, and a program and fixed data are stored therein. In addition, the CPU is a central processor unit, and is operated in accordance with a control program stored in advance in the ROM. The EEPROM is a read-only memory which is electrically erasable and rewritable, and various set value information and the like are stored therein. The RAM is a random access memory, and has a data area for storing various data used in the process of processing by the CPU as well as a work area which is used at the time of processing.

The wireless transmitter receiver 26 is a device for transmitting or receiving a control signal to and from a wireless transmitter receiver 31 of the sliding door 3, which will be described later, by wireless. For instance, if the driver operates a power window switch for a power window of the sliding door 3, the wireless transmitter receiver 26 is adapted to transmit to the wireless transmitter receiver 31 a control signal for raising or lowering the window of the sliding door 3. It should be noted that although in this embodiment the wireless transmitter receiver 26 is arranged to transmit or receive various control signals by wireless, the wireless transmitter receiver 26 may be alternatively arranged to transmit or receive them by wire or electromagnetic induction (using a cable, the action of mutual induction, or the like). The wireless transmitter receiver 26 may transmit or receive the control signals by communication using light, infrared rays, or the like.

The feeding control switch 14 is, for instance, a relay having a known configuration, and its on/off state is controlled by the vehicle body-side control unit 13. As the feeding control switch 14 is turned on and off, the supply of electric power to the primary-side electromagnetic induction coil unit 6 can be controlled.

As the aforementioned switches 15, it is possible to cite various switches including a centralized door lock switch and power window switches.

The sliding door 3 is provided with a door stay 27 (see FIG. 3) located in its lower portion. The door stay 27 is arranged to be guided by a rail portion 28 (see FIG. 1) provided in the lower portion of the open frame portion 4 of the vehicle body 2. Namely, an unillustrated roller is provided at a tip of the door stay 27, and the roller is adapted to slide on the rail portion 28. The door stay 27 is adapted to move in the longitudinal direction (see the directions of arrows in FIG. 3) of the vehicle body 2 together with the sliding door 3. Incidentally, in a case where the aforementioned various control signals are transmitted or received by a cable, the door stay 27 can be used as a bridge for stretching the cable.

The secondary-side feeding coil 10 is one having a known configuration and is provided to secure a power supply of 12 V. A covering made of a synthetic resin is provided on its surface so as to demonstrate an effect with respect to splashing with water (such as splashing with drops of water from the outside). In addition, a proximate fitting surface 29 of the secondary-side feeding coil 10 is disposed and formed so as to be capable of opposing and approaching the proximate fitting surface 25 of the primary-side feeding coil 8.

Meanwhile, the secondary-side feeding coil 11 which is disposed in parallel with the secondary-side feeding coil 10 is one having a known configuration in the same way as the secondary-side feeding coil 10, and is provided to secure a power supply of 5 V. Namely, as compared with the secondary-side feeding coil 10, the secondary-side feeding coil 11 is formed with a different winding ratio with respect to the primary-side feeding coil 8. A covering made of a synthetic resin is provided on the surface of the secondary-side feeding coil 11 so as to demonstrate an effect with respect to splashing with water (such as splashing with drops of water from the outside) In addition, a proximate fitting surface 30 of the secondary-side feeding coil 11 is disposed and formed so as to be capable of opposing and approaching the proximate fitting surface 25 of the primary-side feeding coil 8.

The rectifier circuit 12 (or a rectifying/charging function circuit) is configured by including a rectifier circuit for rectifying the induced electromotive force occurring in each of the secondary-side feeding coil 10 and the secondary-side feeding coil 11, as well as a charging circuit for charging the first storage member 20 and the second charging member 22 with the induced electromotive force occurring in each of the secondary-side feeding coil 10 and the secondary-side feeding coil 11.

The load driving circuit 17 is arranged to be able to drive the intermittent load 23 provided on the sliding door 3 in correspondence with the operation of the door switches 24. In addition, the load driving circuit 17 is arranged to be able to drive the intermittent load 23 in response to a control signal from the control circuit 18.

As the door switches 24, it is possible to cite various switches including door opening/closing handle switches and power window opening/closing switches. As the intermittent load 23, it is possible to cite various intermittent loads (loads) including power windows, door locks, and electrically-operated sliding-door opening and closing.

The control circuit 18 controls the driving of various intermittent loads 23 and the like provided on the sliding door 3, and is configured by including an unillustrated microprocessor and its peripheral circuits. In addition, the control circuit 18 is arranged to monitor the state of charging (charging rate) of the first storage member 20 and the second storage member 22. The control circuit 18 is arranged to control the on/off state of each of the first charging switch 19 and the second charging switch 21.

In addition, the control circuit 18 is configured by integrally including the wireless transmitter receiver 31 (which may be a separate unit). The wireless transmitter receiver 31 is a device for transmitting or receiving a control signal with respect to the intermittent load 23 or the like to and from the wireless transmitter receiver 26 on the vehicle body 2 side.

The first charging switch 19 is, for instance, a relay having a known configuration, and is capable of controlling the charging of the first storage member 20 as the first charging switch 19 is turned on and off by being controlled by the control circuit 18.

The second charging switch 21 is, for instance, a relay having a known configuration in the same way as the first charging switch 19, and is capable of controlling the charging of the second storage member 22 as the second charging switch 21 is turned on and off by being controlled by the control circuit 18.

As the first storage member 20, in this embodiment, a capacitor which is a power source having a known configuration is applied. In other words, the capacitor is used in this embodiment to satisfy the characteristic requirements of the intermittent load 23 (large-current discharging is effected only during the load operating time).

The charging of the first storage member 20 is controlled by the turning on and off of the first charging switch 19. In addition, the first storage member 20 is capable of supplying electric power of 12 V to the load driving circuit 17.

As the first storage member 20, a large-capacity storage member such as the vehicle body-side battery 16 is not required, and a compact one having a capacity sufficient to drive the intermittent load 23 is used. In addition, the first storage member 20 is installed replaceably on the sliding door 3 (the use of the capacity prolongs the durable life and invariably leads to a maintenance-free condition, but it is desirable to install the first storage member 20 in a replaceable manner).

It should be noted that as the first storage member 20 (capacitor), a large-capacity type device such as an electric double layer capacitor or a polyacen capacitor is preferable. As the capacity, 20 to 500 F. is desirable. It suffices to select one having an appropriate capacity within the range which makes it possible to drive the intermittent load. It goes without saying that if a capacitor having a necessary and minimum capacity is selected, it is possible to reduce the weight, shorten the charging time, make the space compact, lower the cost, and reduce the amount of electric power generated on the primary coil side.

As the second storage member 22, in this embodiment, a secondary battery which is a power source having a known configuration is applied. In other words, the secondary battery is used in this embodiment to satisfy the characteristic requirements of the control circuit 18 (electric power, although small in its current, is supplied for a long time).

The charging of the second storage member 22 is controlled by the turning on and off of the second charging switch 21. In addition, the second storage member 22 is capable of supplying electric power of 5 V to the load control circuit 18.

As the second storage member 22, a large-capacity storage member such as the vehicle body-side battery 16 is not required in the same way as the first storage member 20, and a compact one having a capacity sufficient to drive the control circuit 18 is used. In addition, the second storage member 22 is installed replaceably on the sliding door 3.

It should be noted that the second storage member 22 (secondary battery) may be appropriately selected from among a lead-acid accumulator, a nickel-cadmium battery, a nickel-hydrogen battery, a lithium-ion battery, and the like. In addition, it suffices if a second storage member is selected, as required, which has an appropriate capacity (or a necessary and minimum capacity) and is compact.

In the above-described configuration, the primary-side electromagnetic induction coil unit 6 may be considered as one module (and may include the vehicle body-side control unit 13 or the wireless transmitter receiver 26). Similarly, the secondary-side electromagnetic induction coil unit 7 may be considered as one module (and may include the load driving circuit 17, the control circuit 18, the first charging switch 19, the second charging switch 21, the first storage member 20, and the second storage member 22). It goes without saying that the efficiency in the assembling operation improves as a result. In addition, it can be appreciated from the above-described construction that the cable (the cable for feeding and control signals) is not stretched between the vehicle body 2 and the sliding door 3. It goes without saying that the efficiency in the assembling operation improves.

Next, referring to FIG. 4, a description will be given of a detailed example of the configuration of the feeder section 5. Incidentally, reference will be made to FIG. 2, as required.

In FIG. 4, when the feeding control switch 14 is turned on, electric power of +12 V is supplied from the vehicle body-side battery 16 to one end of the primary-side feeding coil 8 of the feeder section 5. The line between the feeding control switch 14 and one end of the primary-side feeding coil 8 is grounded via a capacitor C1. A collector of a transistor Tr1 is connected to the other end of the primary-side feeding coil 8, and an emitter thereof is grounded. An oscillation output from an oscillator circuit 32 is supplied to a base of the transistor Tr1, and the transistor Tr1 is adapted to be turned on and off by that oscillation output. When the transistor Tr1 is turned on and off, an ac electromotive force is generated in the primary-side feeding coil 8. As for the oscillation frequency of the oscillator circuit 32, a frequency of such as 100 kHz which is other than an audible frequency in the range of 30 kHz to 500 kHz and which does not adversely affect the various portions of the vehicle is preferable.

A first rectifier circuit 33 of the rectifier circuit 12, which consists of a diode D1 and a capacitor C2, is connected to the secondary-side feeding coil 10 of the feeder section 5. In addition, a second rectifier circuit 34 of the rectifier circuit 12, which consists of a diode D2 and a capacitor C3, is connected to the secondary-side feeding coil 11 of the feeder section 5. Here, the first rectifier circuit 33 and the second rectifier circuit 34 may be configured by bridge circuits of diodes. When the first charging switch 19 is turned on, the induced electromotive force occurring in the secondary-side feeding coil 10 due to the action of mutual induction with the primary-side feeding coil 8 is charged in the first storage member 20 which is the capacitor. In a case where the first charging switch 19 is off, electric power is supplied to the load driving circuit 17 from the first storage member 20. Meanwhile, when the second charging switch 21 is turned on, the induced electromotive force occurring in the secondary-side feeding coil 11 due to the action of mutual induction with the primary-side feeding coil 8 is charged in the second storage member 22 which is the battery cell. In a case where the second charging switch 21 is off, electric power is supplied to the control circuit 18 from the second storage member 22.

Incidentally, a description will be given in greater detail of the charging of the first storage member 20 which is the capacitor. A method is adopted in which in a state in which the sliding door 3 is closed with respect to the vehicle body 2, and when the intermittent load 23 (see FIG. 2) is not being operated, the first charging switch 19 and the feeding control switch 14 are turned on, and an induced electromotive force is caused in the secondary-side feeding coil 10 through the action of mutual induction with the primary-side feeding coil 8 so as to effect charging. In addition, as for the charging of the second storage member 22 which is the secondary battery, a method is adopted in which when the sliding door 3 is closed with respect to the vehicle body 2, the second charging switch 21 and the feeding control switch 14 are turned on, and an induced electromotive force is caused in the secondary-side feeding coil 11 through the action of mutual induction with the primary-side feeding coil 8 so as to effect charging.

As has been described above with reference to FIGS. 1 to 4, in this embodiment, the arrangement provided is such that the supply of electric power is effected through the action of mutual induction between the two members on the vehicle body 2 side and the sliding door 3 side without directly establishing electric connection by means of an electric wire or the like or via an electric connector (in other words, the arrangement provided is such that the electric power system (including the signal system as well) is connected on a non-contact basis). In addition, the arrangement provided is such that respectively different induced electromotive forces are caused to occur in the secondary-side feeding coils 10 and 11, and the supply of electric power is effected for each of the secondary-side feeding coils 10 and 11 (the arrangement has a voltage conversion function) . The arrangement provided is such that the first storage member 20 and the second storage member 22 are respectively connected to the secondary-side feeding coils 10 and 11 with the rectifier circuit 12 interposed therebetween, so as to supply electric power corresponding to the characteristic requirements of the corresponding loads (the intermittent load 23 and the control circuit 18).

Accordingly, it is possible to cut back voltage conversion circuit components which are conventionally required. In addition, as the result of the fact that the voltage conversion circuit components can be cutback, it is possible to suppress the heating power loss and the effect of noise. On the other hand, since the first storage member 20 and the second storage member 22 are used, the capacities of the storage members do not become large, which is otherwise the case with a single voltage storage member, so that it is possible to reduce the weight, shorten the charging time, make the space compact, lower the cost, and reduce the amount of electric power generated by the vehicle body-side battery 16.

The feeder apparatus in accordance with this embodiment is able to reduce the cost and supply electric power with high efficiency. It should be noted that if the difference increases between the voltage of the power supply for driving the intermittent load 23 and the voltage of the power supply for control, advantages far greater than the above-described advantages can be expected.

In addition, it goes without saying that various modifications can be made within the range that does not change the gist of the invention. Namely, although in the above-described embodiment a description has been given of the case in which the number of the secondary-side feeding coils 10 and 11 is two, the invention is not limited to the same. For example, arrangements are conceivable which are based on the combination of cases in which the power supply on the vehicle body 2 side is 12 or 36 V, the power supply for driving the intermittent load 23 on the sliding door 3 side is 12 V or 36 V, and the controlling power supply on the sliding door 3 side is 3 V or 5 V, so that the number of the secondary-side feeding coils is not limited to two.

In addition, although in the above-described embodiment the primary-side feeding coil 8 is configured as a single unit, two primary-side feeding coils 8 of the same configuration may be juxtaposed so as to correspond one-to-one with the secondary-side feeding coils 10 and 11.

Although in the above-described embodiment the examples of the first and second members recited in the claims are set as the vehicle body 2 and the sliding door 3, the invention is not limited to the same. For example, the vehicle body and a door unit other than the sliding door, and a tuner and a speaker in audio equipment can be cited as the first and second members. As other examples, it is possible to cite the steering of a door (the other member side: a steering portion) and a seat of an automobile (the other member side: a seat portion) It suffices if the two members require the supply of electric power on a non-contact basis.

As described above, in accordance with the invention, the supply of electric power can be effected through the action of mutual induction between the primary coil and the plurality of secondary coils which are brought into close proximity to the primary coil. Namely, respectively different induced electromotive forces are caused occur in the plurality of secondary coils, and the supply of electric power can be effected for each of the secondary coils. Consequently, it is possible to cut back voltage conversion circuit components which are conventionally required. In addition, it becomes possible to suppress the heating power loss and the effect of noise. Accordingly, it is possible to provide a feeder apparatus capable of supplying electric power efficiently with reduced cost. Incidentally, if the difference between the voltage of a power supply for driving the load and the voltage of a power supply for control increases, the effect becomes greater.

In accordance with the invention, advantages are offered in that it is possible to reduce the weight, shorten the charging time, make the space compact, lower the cost, and reduce the amount of electric power generated on the primary coil side.

What is claimed is:

1. A feeder apparatus:
a first member;
a second member adapted to be brought into close proximity to the first member to supply electric power from the first member to the second member;
at least one primary coil for feeding electric power provided on the first member; and
a plurality of secondary coils for feeding electric power which have different winding ratios to generate different induced electromotive forces when the first member brought into close proximity to the second member, and are provided on the second member.

2. The feeder apparatus according to claim 1, wherein storage members corresponding to characteristic requirements of corresponding loads are respectively connected to the plurality of secondary coils through a rectifier circuit.

3. The feeder apparatus according to claim 2, wherein the first member is provided on a vehicle body, and the second member is provided on a slide door slidably mounted on the vehicle body.

4. The feeder apparatus according to claim 3, wherein the primary coil is electrically connected to a battery mounted on the vehicle body, and the storage members are mounted on the slide door.

5. The feeder apparatus according to claim 2, wherein the storage members includes a first storage member for supplying electric power to a load driving circuit and a second storage member for supplying electric power to a control circuit.

6. The feeder apparatus according to claim 5, wherein the control circuit controls the load driving circuit and monitors a state of charging the first storage member and the second storage member to control it.
